(19) United States
(12) Patent Application Publication
(10) Pub. No.: US 2024/0165752 A1
(43) Pub. Date: May 23, 2024

(54) Installation tool for resiliently-compressible building materials

(71) Applicant: Schul International Co., LLC, Hudson, NH (US)

(72) Inventors: Nicholas A. Fiorilla, Hudson, NH (US); Michael M. Sebold, Cleveland Heights, OH (US); Donald Wallis, Plaistow, NH (US)

(73) Assignee: Schul International Co., LLC, Hudson, NH (US)

(21) Appl. No.: 17/988,920

(22) Filed: Nov. 17, 2022

(51) Int. Cl. B23P 19/04; E04B 1/68

(52) U.S. Cl. CPC B23P 19/047; E04B 1/6812

(57) ABSTRACT

A tool for installing a resiliently-compressible building component adjacent the end of one or panels which may be incorporated into a system including a substrate. The tool has two arms, in a location where the tool moves from a tool first position to a tool second position at a positioning body rate which is not greater than a rate of expansion of the resiliently-compressible building component. A set of arms be attached to a plurality of adjustable adjacent spaced-apart armatures for multiple points of contact. The tool second position width is at least 105% of the tool first position width and is not more than 150% of the tool first position width.

### CROSS-REFERENCE TO RELATED APPLICATIONS

None.

### STATEMENT REGARDING FEDERALLY SPONSORED RESEARCH OR DEVELOPMENT

### BACKGROUND

### Field

The present disclosure relates generally to a tool for installing a resiliently-compressible building component adjacent the end of one or panels. More particularly, the present disclosure is directed to a tool for installing a resiliently-compressible building component, where the tool has two arms, in a location where the tool moves from a tool first position to a tool second position at a positioning body rate which is not greater than a rate of expansion of the resiliently-compressible building component.

### Description of the Related Art

Construction panels come in many different sizes and shapes and may be used for various purposes, including roadways, sideways, and pre-cast structures, particularly buildings. Whether formed in place or by use of precast panels, designs generally require forming a lateral gap or joint between adjacent panels to allow for independent movement, such in response to ambient temperature variations within standard operating ranges, building settling or shrinkage and seismic activity. Moreover, these joints are subject to damage over time. Seals between these panels may be intended to preclude foreign bodies from becoming lodged between the panels, to impede water accumulation between the panels, to prevent exposure by subsurface components to chemicals, to prevent air penetration or escape, and to reduce temperature variations at joints. Similarly, these panels themselves may be resiliently-compressible, such as where the panels are imposed on a framework or other support.

These resiliently-compressible seals and these resiliently-compressible panels are generally installed by manual effort, where a worker must impose the seal or panel in a location while the building material is expanding. Time becomes an issue as a delay at a first end may permit the second end to overly expand, requiring substantial force to re-compress to the associated void size, if possible. This typically is accomplished by a worker beginning at a first end and rapidly positioning successive sections of the building material before it expands along its length beyond the width of the joint or other void. If the resiliently-compressible building material expands beyond that width, the worker must manually compress each successive section.

### SUMMARY

The present disclosure therefore meets the above needs and overcomes one or more deficiencies in the prior art by providing a positioning tool having a first arm, a second arm, and a positioning body, where the first arm has a first arm downwardly-extending member, which has a narrow vertically-oriented first arm downwardly-extending member internal face and a narrow vertically-oriented first arm downwardly extending member external face, where the second arm has a second arm downwardly-extending member, which has a narrow vertically-oriented second arm downwardly-extending member internal face and a narrow vertically-oriented second arm downwardly extending member external face, and where the positioning body is attached to the first arm at a positioning body first connection end, is attached to the second arm at a positioning body second connection end, is positioned above the first arm downwardly-extending member and the second arm downwardly-extending member, and is configured to maintain the first arm relative to the second arm in tool first position, wherein in the tool first position the narrow vertically-oriented first arm downwardly-extending member internal face contacts a resiliently-compressible building component, the resiliently-compressible building component in compression, and the narrow vertically-oriented second arm downwardly-extending member internal face oppositely contacts the resiliently-compressible building component, the narrow vertically-oriented first arm downwardly-extending member internal face distant the narrow vertically-oriented second arm downwardly-extending member internal face by a tool first position width, and where the positioning body is configured to permit the first arm and the second arm to move from the tool first position to a tool second position at a positioning body rate not greater than a rate of expansion of the resiliently-compressible building component while maintaining the narrow vertically-oriented first arm downwardly-extending member internal face in contact with the resiliently-compressible building component and while maintaining the narrow vertically-oriented second arm downwardly-extending member internal face in opposing contact with the resiliently-compressible building component, and where the positioning body is configured to maintain the first arm relative to the second arm in the tool second position, wherein in the tool second position the narrow vertically-oriented first arm downwardly-extending member internal face contacts the resiliently-compressible building component and the narrow vertically-oriented second arm downwardly-extending member internal face oppositely contacts the resiliently-compressible building component, the narrow vertically-oriented first arm downwardly-extending member internal face distant the narrow vertically-oriented second arm downwardly-extending member internal face by a tool second position width, the second position width greater than the tool first position width, the tool second position width being at least 105% of the tool first position width and not more than 150% of the tool first position width.

The present disclosure further provides a positioning tool having a plurality of adjustable adjacent spaced-apart armatures, each armature having a first arm, a second arm, and a positioning body, where each first arm has a first arm downwardly-extending member, which has a narrow vertically-oriented first arm downwardly-extending member internal face and a narrow vertically-oriented first arm downwardly extending member external face, where each second arm has a second arm downwardly-extending member, which has a narrow vertically-oriented second arm downwardly-extending member internal face and a narrow vertically-oriented second arm downwardly extending member external face, and where each positioning body is attached to the first arm at a positioning body first connection end, is attached to the second arm at a positioning body second connection end, is positioned above the first arm downwardly-extending member and the second arm downwardly-extending member, and is configured to maintain the first arm relative to the second arm in tool first position, wherein in the tool first position the narrow vertically-oriented first arm downwardly-extending member internal face contacts a resiliently-compressible building component, the resiliently-compressible building component in compression, and the narrow vertically-oriented second arm downwardly-extending member internal face oppositely contacts the resiliently-compressible building component, the narrow vertically-oriented first arm downwardly-extending member internal face distant the narrow vertically-oriented second arm downwardly-extending member internal face by a tool first position width, and where the positioning body is configured to permit the first arm and the second arm to move from the tool first position to a tool second position at a positioning body rate not greater than a rate of expansion of the resiliently-compressible building component while maintaining the narrow vertically-oriented first arm downwardly-extending member internal face in contact with the resiliently-compressible building component and while maintaining the narrow vertically-oriented second arm downwardly-extending member internal face in opposing contact with the resiliently-compressible building component, and where the positioning body is configured to maintain the first arm relative to the second arm in the tool second position, wherein in the tool second position the narrow vertically-oriented first arm downwardly-extending member internal face contacts the resiliently-compressible building component and the narrow vertically-oriented second arm downwardly-extending member internal face oppositely contacts the resiliently-compressible building component, the narrow vertically-oriented first arm downwardly-extending member internal face distant the narrow vertically-oriented second arm downwardly-extending member internal face by a tool second position width, the second position width greater than the tool first position width, the tool second position width being at least 105% of the tool first position width and not more than 150% of the tool first position width.

The present disclosure further provides a system for positioning an expansion joint seal adjacent a first side of a first substrate, which includes a positioning tool, the expansion joint seal, and the first substrate, where the positioning tool has a first arm, a second arm, and a positioning body, the first arm having a first arm downwardly-extending member, the first arm downwardly-extending member having a narrow vertically-oriented first arm downwardly-extending member internal face and a narrow vertically-oriented first arm downwardly extending member external face, the second arm having a second arm downwardly-extending member, the second arm downwardly-extending member having a narrow vertically-oriented second arm downwardly-extending member internal face and a narrow vertically-oriented second arm downwardly extending member external face, the positioning body attached to the first arm at a positioning body first connection end, the positioning body attached to the second arm at a positioning body second connection end, the positioning body positioned above the first arm downwardly-extending member and the second arm downwardly-extending member, wherein the positioning body is configured to maintain the first arm relative to the second arm in tool first position, wherein in the tool first position the narrow vertically-oriented first arm downwardly-extending member internal face contacts a resiliently-compressible building component, the resiliently-compressible building component in compression, and the narrow vertically-oriented second arm downwardly-extending member internal face oppositely contacts the resiliently-compressible building component, the narrow vertically-oriented first arm downwardly-extending member internal face distant the narrow vertically-oriented second arm downwardly-extending member internal face by a tool first position width, where the positioning body is configured to permit the first arm and the second arm to move from the tool first position to a tool second position at a positioning body rate not greater than a rate of expansion of the resiliently-compressible building component while maintaining the narrow vertically-oriented first arm downwardly-extending member internal face in contact with the expansion joint seal and while maintaining the narrow vertically-oriented second arm downwardly-extending member internal face in opposing contact with the resiliently-compressible building component, and where the positioning body is configured to maintain the first arm relative to the second arm in the tool second position, wherein in the tool second position the narrow vertically-oriented first arm downwardly-extending member internal face contacts the resiliently-compressible building component and the narrow vertically-oriented second arm downwardly-extending member internal face oppositely contacts the resiliently-compressible building component, the narrow vertically-oriented first arm downwardly-extending member internal face distant the narrow vertically-oriented second arm downwardly-extending member internal face by a tool second position width, the second position width greater than the tool first position width, the tool second position width being at least 105% of the tool first position width and not more than 150% of the tool first position width, where the positioning tool is configured to maintain the expansion joint seal between the first arm downwardly-extending member and second arm downwardly-extending member in a lesser-compressed state in the tool second position, a density of the expansion joint seal being greater in the tool first position than in the tool second position, and where the first arm downwardly-extending member is configured for positioning adjacent the first side of the first substrate.

Additional aspects, advantages, and embodiments of the disclosure will become apparent to those skilled in the art from the following description of the various embodiments and related drawings.

### BRIEF DESCRIPTION OF THE DRAWINGS

So that the manner in which the described features, advantages, and objects of the disclosure, as well as others which will become apparent, are attained and can be understood in detail; more particular description of the disclosure briefly summarized above may be had by referring to the embodiments thereof that are illustrated in the drawings, which drawings form a part of this specification. It is to be noted, however, that the appended drawings illustrate only typical preferred embodiments of the disclosure and are therefore not to be considered limiting of its scope as the disclosure may admit to other equally effective embodiments.

In the drawings:

FIG. 1 provides a perspective view of one embodiment of the present disclosure in a tool first position.

FIG. 1A provides a perspective view of one embodiment of the present disclosure in a tool first position in contact with a resiliently-compressible building component.

FIG. 2 provides a perspective view of one embodiment of the tool in a tool second position.

FIG. 3 provides an end-view of the positioning tool with an expansion joint seal and a first substrate and a second substrate, the tool provides for installation of an expansion joint seal.

FIG. 4 provides a close-up of a potential construction of the first arm.

FIG. 5 provides an end view of the positioning tool having a processor and linear positioning device.

FIG. 6 provides an illustration of a positioning tool having a plurality of armatures, each having a first arm, second arm, and positioning tool.

FIG. 7 provides an end view of the position tool having a removal body.

### DETAILED DESCRIPTION

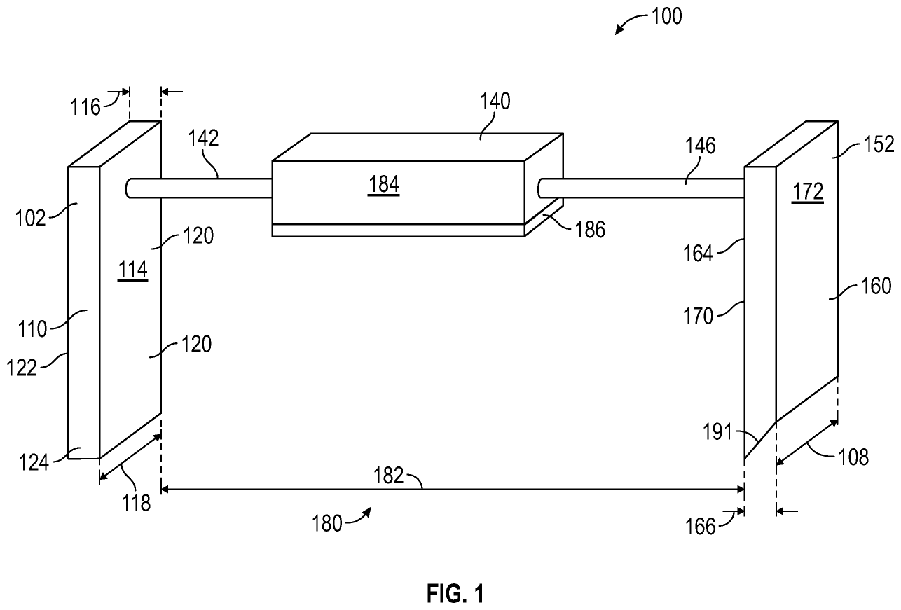

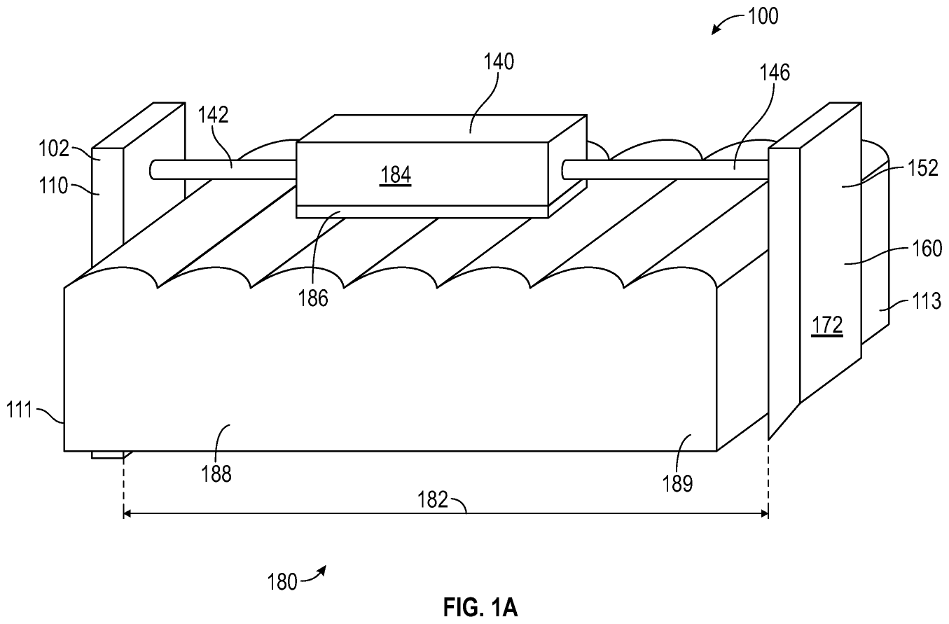

A positioning tool 100 is provided for installing a resiliently-compressible building component. Referring to FIG. 1, a perspective view of one embodiment of the present disclosure is provided. The positioning tool 100 includes a first arm 102, second arm 152, and a positioning body 140. The first arm 102 has a first arm downwardly-extending member 110, where the first arm downwardly-extending member 110 has a narrow vertically-oriented first arm downwardly-extending member internal face 114 and a narrow vertically-oriented first arm downwardly extending member external face 122, having a first arm edge 124 intermediate the narrow vertically-oriented first arm downwardly-extending member internal face 114 and the narrow vertically-oriented first arm downwardly extending member external face 122. The first arm downwardly-extending member 110 has a first arm downwardly-extending member thickness 116. The first arm downwardly-extending member internal face 114 has a height at least four times a narrow vertically-oriented first arm downwardly-extending member internal face width 118. The second arm 152 has a second arm downwardly-extending member 160, where the second arm downwardly-extending member 160 has a narrow vertically-oriented second arm downwardly-extending member internal face 164 and a narrow vertically-oriented second arm downwardly extending member external face 172. The second arm downwardly-extending member internal face 164 has a height at least four times a narrow vertically-oriented second arm downwardly-extending member internal face width 168. The second arm 152 may be parallel to the first arm 102. The second arm downwardly-extending member 160 has a second arm downwardly-extending member thickness 166. The lower end of the second arm downwardly-extending member 160 may be beveled to provide a wedge end 191 for insertion or may be rounded to encourage sufficient deflection to aid in installation. The first arm downwardly-extending member 110 may likewise be constructed. The positioning body 140 is attached to the first arm 102 at a positioning body first connection end 142 and is attached to the second arm 152 at a positioning body second connection end 146. The positioning body 140 is positioned above the first arm downwardly-extending member 110 and the second arm downwardly-extending member 160. The positioning body 140 is configured to maintain the first arm 102 relative to the second arm 152 in tool first position 180.

Referring to FIG. 1A, in the tool first position 180, the narrow vertically-oriented first arm downwardly-extending member internal face 114 contacts a resiliently-compressible building component 188, the resiliently-compressible building component 188 in compression, and the narrow vertically-oriented second arm downwardly-extending member internal face 164 oppositely contacts the resiliently-compressible building component 188, where the narrow vertically-oriented first arm downwardly-extending member internal face 114 is distant the narrow vertically-oriented second arm downwardly-extending member internal face 164 by a tool first position width 182. The tool first position width 182 may be selected by the user or may be fixed for a particular positioning tool 100. A range of resiliently-compressible building components 188 may potentially be used when the positioning tool accommodates different sizes. The narrow vertically-oriented first arm downwardly-extending member thickness 116 is thin compared to the tool first position width 182. The narrow vertically-oriented second arm downwardly-extending member thickness 166 is thin compared to the tool first position width 182.

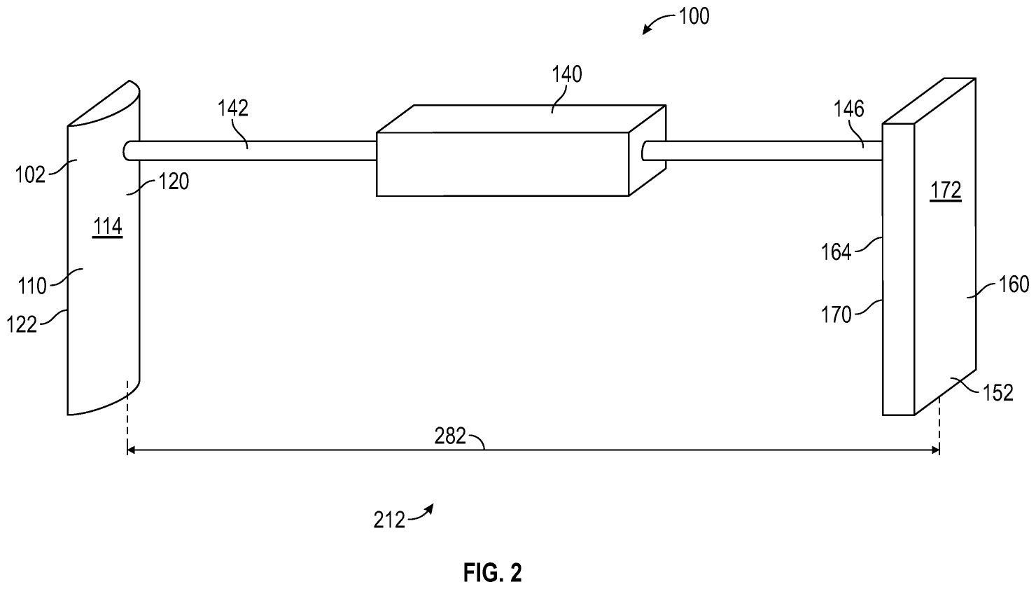

Referring to FIG. 2, a perspective view of one embodiment of the tool 100 in a tool second position 212 is provided. The positioning body 140 is configured to maintain the first arm 102 relative to the second arm 152 in the tool second position 212. In the tool second position 212, the narrow vertically-oriented first arm downwardly-extending member internal face 114 contacts the resiliently-compressible building component 188 and the narrow vertically-oriented second arm downwardly-extending member internal face 164 oppositely contacts the resiliently-compressible building component 188, while the narrow vertically-oriented first arm downwardly-extending member internal face 114 distant the narrow vertically-oriented second arm downwardly-extending member internal face 164 by a tool second position width 282, the second position width greater than the tool first position width 182, the tool second position width 282 being at least 105% of the tool first position width 182 and not more than 150% of the tool first position width 182. The tool second position width 282 may be selected by the user or may be fixed for a particular positioning tool 100 within this range. A range of resiliently-compressible building components 188 may potentially be used when the positioning tool accommodates different sizes.

Referring to FIGS. 1 and 2, the positioning body 140 is configured to permit the first arm 102 and the second arm 152 to move from the tool first position 180 to the tool second position 212 at a positioning body rate not greater than a rate of expansion of the resiliently-compressible building component 188 while maintaining the narrow vertically-oriented first arm downwardly-extending member internal face 114 in contact with the resiliently-compressible building component 188 and while maintaining the narrow vertically-oriented second arm downwardly-extending member internal face 164 in opposing contact with the resiliently-compressible building component 188. When desired, the positioning tool 100 may include a position processor 184 configured to record the quantity of changes from the tool first position 180 to the tool second position 212.

Beneficially, the positioning tool 100 thus can engage the resiliently-compressible building component 188 by pinching the resiliently-compressible building component 188 on its sides without requiring engagement from the underside of the resiliently-compressible building component 188. When positioning tool 100 positions the resiliently-compressible building component 188 where desired, positioning tool 100 cannot drop the resiliently-compressible building component 188, but instead ensures continuing contact with the resiliently-compressible building component 188 as it expands until the resiliently-compressible building component 188 ceases to expand, whether by external constraints maintaining some degree of compression or by reaching its uncompressed size. As can be appreciated, any engagement from below the resiliently-compressible building component 188 by the tool would have the potential to frustrate removal of positioning tool 100 when the resiliently-compressible building component 188 is positioned laterally adjacent one or more other bodies and when positioning tool 100 or when positioning tool 100 is separated vertically from the resiliently-compressible building component 188. The engagement of positioning tool 100 with the resiliently-compressible building component 188, because of the resiliently-compressible nature of the building component, does not damage the resiliently-compressible building component 188 and permits its installation or positioning, particularly when removal without damaging or dropping is paramount. Such use is made possible because positioning tool 100 has a positioning body rate not greater than a rate of expansion of the resiliently-compressible building component 188 during movement from the tool first position 180 to the tool second position 212. This positioning body rate may be controlled in the positioning body 140 by control of a linear positioning system where speed of advance may be controlled, such as by a stepper motor, or may be controlled in the positioning body by a spring-and-damper assembly configured to release upon command.

The tool 100 may be used where the resiliently-compressible building component 188 is an expansion joint seal 189, such as a foam-based expansion joint seal 189 which may include one or more fillers and/or fire-retardant materials. Such expansion joint seals 189 are required to be compressed to a width narrower than the space between substrates, such as roadway sections or wall panels and then permitted to move to a lower state of compression, maintaining contact with both substrate surfaces, sometimes by being adhered to the walls.

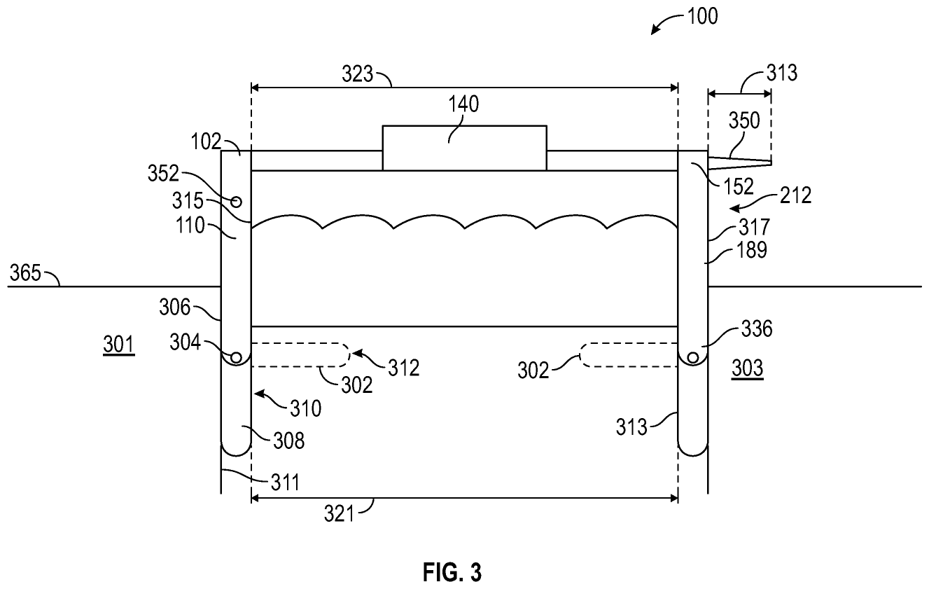

When desired, positioning tool 100 may be further detailed for contact with an expansion joint seal 189. Beneficially, positioning tool 100 does not contact the entirety of the expansion joint seal 189, but only a portion of it. Referring to FIGS. 1A and 3, an end-view of the positioning tool 100 with an expansion joint seal 189 and a first substrate 301 and a second substrate 302, the tool provides for installation of an expansion joint seal 189. The expansion joint seal 189 may have an expansion joint seal first side 111 configured to contact a first substrate end face 311 of the first substrate 301 and may have an expansion joint seal second side 113 configured to contact a second substrate end face 313 of the second substrate 303. In the tool second position 212, the narrow vertically-oriented first arm downwardly-extending member internal face 114 is configured to contact an expansion joint seal first side segment 315 of the expansion joint seal first side 111, the first arm downwardly-extending member 110 is removably positioned between the expansion joint seal first side segment 315 and the first substrate end face 311, the narrow vertically-oriented second arm downwardly-extending member internal face 164 configured to contact an expansion joint seal second side segment 317 of the expansion joint seal second side 113, and the second arm downwardly-extending member 160 removably positioned between the expansion joint seal second side segment 317 and the second substrate end face 313. The narrow vertically-oriented first arm downwardly-extending member internal face 114 the narrow vertically-oriented narrow vertically-oriented second arm downwardly-extending member internal face 164 ensures only a small portion of the expansion joint seal 189 contacts positioning tool 100, while the balance can contact the first substrate end face 311 and the second substrate end face 313.

Because the positioning body rate ensures continuing contact between positioning tool 100 and the expansion joint seal 189 as the expansion joint seal 189 is permitted to expand between the first substrate end face 311 and the second substrate end face 313, positioning tool 100 maintains the position of the expansion joint seal 189 during its installation. The balance of the expansion joint seal first side 111, with the exception of the expansion joint seal first side segment 315, and the balance of the expansion joint seal second side 113, with the exception of the expansion joint seal second side segment 317, contact the respective and adjacent first substrate end face 311 and second substrate end face 313 and thereby bond in position.

When desired, a portion of positioning tool 100 may be sacrificial, avoiding the potential for any ripping or damage associated with removal of positioning tool 100 when positioned between the resiliently-compressible building component 188 and any substrate or adjacent object. In such a circumstance, a portion of the first arm downwardly-extending member 110 is detachable, and a portion of the second arm downwardly-extending member 160 is detachable.

An alternative to or combination with a sacrificial component to ease the movement positioning tool 100 when positioned between the resiliently-compressible building component 188 and any substrate or adjacent object may be selection of the shape or surface of the narrow vertically-oriented first arm downwardly-extending member internal face 114. Referring to FIG. 2, the narrow vertically-oriented first arm downwardly-extending member internal face 114 may be convex 220. A smooth surface for the internal faces can therefore be beneficial. Referring to FIGS. 1, 1A, and 2, as expansion joint seals 189 may include an adhesive on their expansion joint seal first side 111 and expansion joint seal second side 113, a smooth surface which reduces adhesion can be used. The positioning tool 100 may be provided where the narrow vertically-oriented first arm downwardly-extending member internal face 114 has a first arm downwardly-extending member internal face surface 120 and the narrow vertically-oriented second arm downwardly-extending member internal face 164 has a second arm downwardly-extending member internal face surface 170. Each of the first arm downwardly-extending member internal face surface 120 and second arm downwardly-extending member internal face surface 170 are the provided a Roughness Average Ra of not more than 32 μ-in. Ra is described in ASME B46.1 as “the arithmetic average of the absolute values of the profile height deviations from the mean line, recorded within the evaluation length.” Ra is thus calculated as the Roughness Average of a surface's measured microscopic peaks and valleys.

It may be desirable to select the level of friction associated with the positioning tool 100, as it must grasp the resiliently-compressible building component 188. When so desired, the first arm downwardly-extending member internal face surface 120 and the second arm downwardly-extending member internal face surface 170 may have a coefficient of friction of at least 0.2.

Because the positioning tool 100 may be used to position a resiliently-compressible building component 188 adjacent other construction materials, such as the substrate end face 311 and second substrate end face 313, it may be desirable to control the depth at which the positioning tool 100 positions the resiliently-compressible building component 188. Referring to FIG. 3, a depth control tab 350 may extend outward from one of the narrow vertically-oriented first arm downwardly extending external face 122 and the narrow vertically-oriented second arm downwardly extending external face 172, preventing the positioning tool 100 from extending further into the space between the first substrate 301 and the second substrate 303. When desired, the depth control tab 350 may have a depth control tab width 315 at least equal to the difference of the tool first position width 182 and the tool second position width 282. Alternatively, or in addition, the positioning tool 100 may be provided with a depth control sensor 352 within the first arm 102 configured to monitor the depth of the first arm 102 relative to an adjacent substrate top surface 365 of the first substrate 301.

Referring to FIG. 3, it may be desirable to provide a mechanism to provide upward support to the resiliently-compressible building component 188 prior to removal of the positioning tool 100. It may therefore be desired to provide a portion of the portion of the first arm downwardly-extending member 110 which temporarily provides support before moving to a position to enable removal. The positioning tool 100 may therefore, when desired, further include a locking member 302 which is rotationally attached at a locking member first end 304 to the first arm 102 at a first arm lower end 306. Such a locking member 302 would have a locking member second end 308 opposite the locking member first end 304, a locking member first position 310 wherein the locking member 302 downwardly descends from the first arm lower end 306, and a locking member second position 312 wherein the locking member second end 308 is intermediate the first arm lower end 306 and the second arm 152. The locking mechanism 314 may be configured to move the locking member 302 between the locking member first position 310 and the locking member second position 312. When desirable, in the locking member second position 312 the locking member second end 308 is perpendicular the first arm 102 in the locking member first position 310.

Referring to FIG. 3, to provide some greater pinch between the first arm 102 and the second arm 152, the two arms may be not parallel. In such a construction, a lower end distance 321 between a first arm lower end 306 and a second arm lower end 336 is less than the distance 323 between a point of attachment of the first arm 102 to the positioning body 140 at the positioning body first connection end 142 and a point of attachment of the second arm 152 to the positioning body 140 at a positioning body second connection end 146. The resulting narrowing between the first arm 102 and the second arm 152 at the lower ends provides an increased support and retention of the resiliently-compressible building component 188.

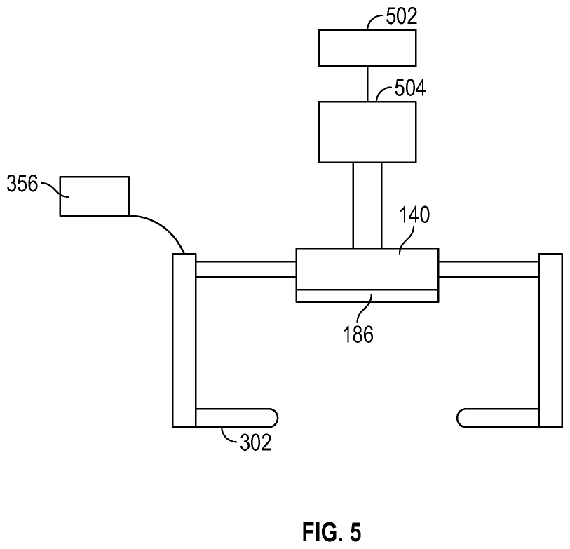

Referring to FIG. 5, an end view of the positioning tool 100 having a processor and linear positioning device 354 is provided. It may be desirable to include processors and linear positioning devices in the positioning tool 100 when the locking member 302 is included. The positioning tool 100 may include a movement processor 502 configured to control a linear positioning device 504 to lower the first arm 102 relative to the first substrate 301 until reaching an installation depth below the first substrate top surface 365. The movement processor 502 may be configured to control a locking member actuator 356 to engage the locking mechanism 314 to move the locking member 302 between the locking member first position 310 and the locking member second position 312. The movement processor 502 may configured to control a linear actuator 186 associated with the positioning body 140 to move the positioning body 140 from the tool first position 180 to the tool second position 212.

The positioning tool 100 may be lifted away from the first substrate 301 and the second substrate 302 after installation, including by mechanical means. The positioning tool 100 may include a movement processor 502 configured to control a linear positioning device 504 to lower the first arm 102 relative to the first substrate 301 until reaching an installation depth below the first substrate top surface 365 where the movement processor 502 is configured to control a locking member actuator 356 to engage the locking mechanism 314 to move the locking member 302 from the locking member second position 312 to the locking member first position 310 after the first arm 102 reaches the installation depth, and the movement processor 502 is configured to control a linear actuator 186 associated with the positioning body 140 to move the positioning body 140 from the tool first position 180 to the tool second position 212 after the locking member 302 moves from the locking member second position 312 to the locking member first position 310, and is configured to control the linear positioning device 504 to raise the first arm 102 relative to the first substrate 301 after moving the positioning body 140 from the tool first position 180 to the tool second position 212.

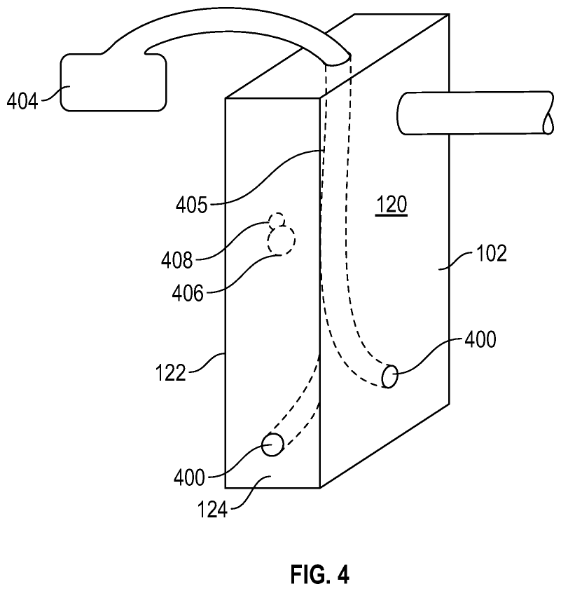

Referring to FIG. 4, a close-up of a potential construction of the first arm 102 is provided. The first arm 102 may be provided to aid in installation of the resiliently-compressible building component 188, particularly where installation includes imposition of a bonding agent on the exterior sides of the resiliently-compressible building component 188 to aid in construction. The positioning tool 100 may include a spray outlet 400 on one of the first arm downwardly-extending member internal face surface 120, the narrow vertically-oriented first arm downwardly extending external face 122, and a first arm first edge 124 intermediate the narrow vertically-oriented first arm downwardly-extending member internal face 114 and a first arm downwardly extending member external face 122. The spray outlet 402 is provided in communication with a spray passage 405 through the first arm 102 where the spray passage 405 is in communication with a spray reservoir 404. The spray reservoir 404 contains an application liquid selected from the group of adhesive, epoxy, solvent, and elastomer. When desired, an application liquid can be sprayed from the positioning tool 100, such as at installation of the resiliently-compressible building component 188 or during removal of the positioning tool 100.

It may also be desirable to provide communication between the installation tool 100 and the resiliently-compressible building component 188. When desired, the resiliently-compressible building component 188 may include a transmitter, identifying desirable details, such as manufacturer, date of manufacture, water intrusion, cycling count. It may therefore be desirable to provide a signal receiver 406 configured to transmit a signal received from the resiliently-compressible building component 188 to a status processor 408.

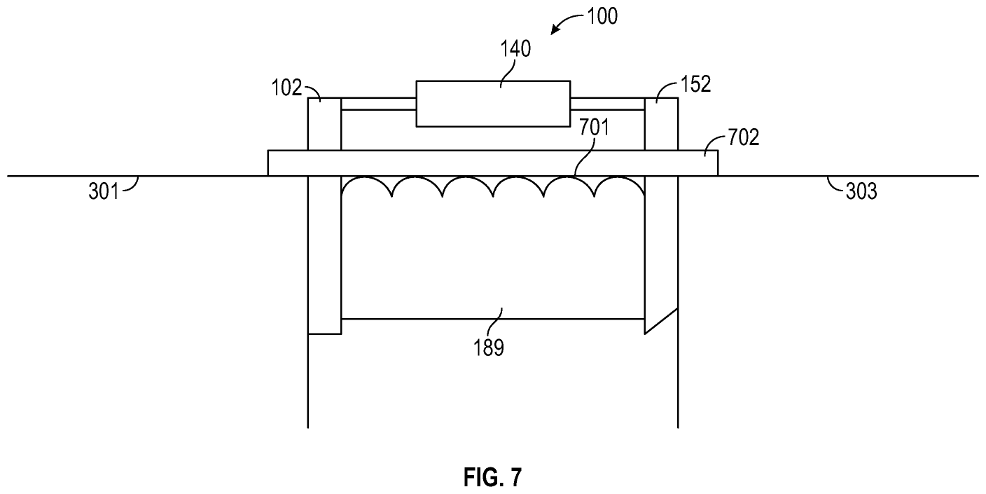

Referring to FIG. 7, an end view of the position tool 100 having a removal body 702 is provided. The positioning tool 100 reduces the potential for damage to an expansion joint seal 189 or other imposed 188 resiliently-compressible building component 188, which may be further reduced by the positioning tool 100 including a removal body 702 which applies a downward force against the expansion joint seal 189 or other imposed 188 resiliently-compressible building component 188 when the first arm 102 and the second arm 152 are removed from contact with the adjacent first substrate 301 and second substrate 301. The positioning tool 100 may further include a removal body configured to maintain position in contact with a top surface of the resiliently-compressible building component 188 and to an adjacent first substrate 354 when the first arm 102 contacts the first substrate 354 and the positioning body 140 is in the tool second position 212.

As can be appreciated, the positioning tool 100 may further include a mechanical repositioning device configured to relocate the positioning body 140 controlled by an operator. Further, the positioning tool 100 may be coupled to devices to transport the resiliently-compressible building component 188, such as drones, robots or other mechanical devices which walk, crawl, roll, navigate underwater, or fly. These may be used in environments such as underwater, below-grade such as in dirt or fill, suspended such as by a rail or crane, or elevated. These may be magnetic or other systems, such as cog-rail.

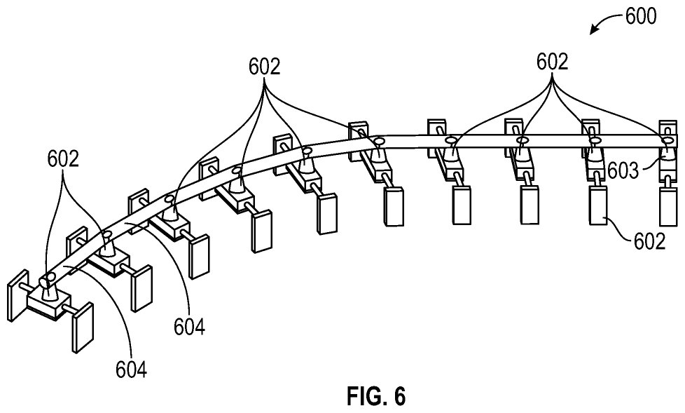

Referring to FIG. 6, an illustration of a positioning tool having a plurality of armatures, each having a first arm, second arm, and positioning tool, is provided. The positioning 100 may include a plurality of adjustable adjacent spaced-apart armatures 602, wherein each armature 602 has a first arm 102, a second arm 152, and a positioning body 140 in the relations provided herein. Each armature 602 may be coupled to each of its adjacent armatures 602 by an articulated arm 604. As a result, a positioning tool 100, looking akin to a centipede, may capture the resiliently-compressible building component 188 at a plurality of locations and the positioning tool 100 articulated between each armature 602 to follow the curvature of any installation location.

A system is thus provided for positioning an expansion joint seal 189 adjacent a first substrate end face 311 of a first substrate 301. The system may include the positioning tool 100, the expansion joint seal 189, and the first substrate 301, where the first arm downwardly-extending member 110 is configured for positioning adjacent the first substrate end face 311 of a first substrate 301. The positioning tool 100 is configured to maintain the expansion joint seal 189 between the first arm downwardly-extending member 110 and second arm downwardly-extending member 160 in a lesser-compressed state in the tool second position 212, the density of the expansion joint seal 189 being greater in the tool first position 180 than in the tool second position 212.

The foregoing disclosure and description is illustrative and explanatory thereof. Various changes in the details of the illustrated construction may be made within the scope of the appended claims without departing from the spirit of the disclosure. The present disclosure should only be limited by the following claims and their legal equivalents.

1. A positioning tool,
comprising:
a first arm,
the first arm having a first arm downwardly-extending member,
the first arm downwardly-extending member having a narrow vertically-oriented first arm downwardly-extending member internal face and a narrow vertically-oriented first arm downwardly extending member external face;
a second arm,
the second arm having a second arm downwardly-extending member,
the second arm downwardly-extending member having a narrow vertically-oriented second arm downwardly-extending member internal face and a narrow vertically-oriented second arm downwardly extending member external face; and
a positioning body,
the positioning body attached to the first arm at a positioning body first connection end,
the positioning body attached to the second arm at a positioning body second connection end,
the positioning body positioned above the first arm downwardly-extending member and the second arm downwardly-extending member,
the positioning body configured to maintain the first arm relative to the second arm in tool first position,
wherein in the tool first position the narrow vertically-oriented first arm downwardly-extending member internal face contacts a resiliently-compressible building component, the resiliently-compressible building component in compression, and the narrow vertically-oriented second arm downwardly-extending member internal face oppositely contacts the resiliently-compressible building component, the narrow vertically-oriented first arm downwardly-extending member internal face distant the narrow vertically-oriented second arm downwardly-extending member internal face by a tool first position width,
the positioning body configured to permit the first arm and the second arm to move from the tool first position to a tool second position at a positioning body rate not greater than a rate of expansion of the resiliently-compressible building component while maintaining the narrow vertically-oriented first arm downwardly-extending member internal face in contact with the resiliently-compressible building component and while maintaining the narrow vertically-oriented second arm downwardly-extending member internal face in opposing contact with the resiliently-compressible building component, and
the positioning body configured to maintain the first arm relative to the second arm in the tool second position,
wherein in the tool second position the narrow vertically-oriented first arm downwardly-extending member internal face contacts the resiliently-compressible building component and the narrow vertically-oriented second arm downwardly-extending member internal face oppositely contacts the resiliently-compressible building component, the narrow vertically-oriented first arm downwardly-extending member internal face distant the narrow vertically-oriented second arm downwardly-extending member internal face by a tool second position width, the second position width greater than the tool first position width, the tool second position width being at least 105% of the tool first position width and not more than 150% of the tool first position width.

2. The positioning tool of claim 1, wherein the resiliently-compressible building component is an expansion joint seal.

3. The positioning tool of claim 2, further comprising:
the expansion joint seal having an expansion joint seal first side configured to contact a first substrate end face of a first substrate;
the expansion joint seal having an expansion joint seal second side configured to contact a second substrate end face of a second substrate;
and wherein in the tool second position:
the narrow vertically-oriented first arm downwardly-extending member internal face is configured to contact an expansion joint seal first side segment of the expansion joint seal first side;
the first arm downwardly-extending member removably positioned between the expansion joint seal first side segment and the first substrate end face;
the narrow vertically-oriented second arm downwardly-extending member internal face configured to contact an expansion joint seal second side segment of the expansion joint seal second side; and
the second arm downwardly-extending member removably positioned between the expansion joint seal second side segment and the second substrate end face.

4. The positioning tool of claim 3, wherein
a portion of the first arm downwardly-extending member is detachable, and
a portion of the second arm downwardly-extending member is detachable.

5. The positioning tool of claim 3, further comprising:
the narrow vertically-oriented first arm downwardly-extending member internal face having a first arm downwardly-extending member internal face surface,
the narrow vertically-oriented second arm downwardly-extending member internal face having a second arm downwardly-extending member internal face surface,
the first arm downwardly-extending member internal face surface having a Roughness Average of not more than 32 μ-in; and
the second arm downwardly-extending member internal face surface having a Roughness Average of not more than 32 μ-in.

6. The positioning tool of claim 3, further comprising:
the narrow vertically-oriented first arm downwardly-extending member internal face having a first arm downwardly-extending member internal face surface,
the narrow vertically-oriented second arm downwardly-extending member internal face having a second arm downwardly-extending member internal face surface,
the first arm downwardly-extending member internal face surface having a coefficient of friction of at least 0.2, and
the second arm downwardly-extending member internal face surface having a coefficient of friction of at least 0.2.

7. The positioning tool of claim 3, further comprising:
a depth control tab extending outward from one of the narrow vertically-oriented first arm downwardly extending external face and the narrow vertically-oriented second arm downwardly extending external face.

8. The positioning tool of claim 3, further comprising
a depth control sensor within the first arm configured to monitor the depth of the first arm relative to a first substrate top surface of the first substrate.

9. The positioning tool of claim 8, further comprising:
a movement processor configured to control a linear positioning device to lower the first arm relative to the first substrate until reaching an installation depth below the first substrate top surface,
the movement processor configured to control a locking member actuator to engage the locking mechanism to move the locking member between the locking member first position and the locking member second position, and
the movement processor configured to control a linear actuator associated with the positioning body to move the positioning body from the tool first position to the tool second position.

10. The positioning tool of claim 8, further comprising:
a movement processor configured to control a linear positioning device to lower the first arm relative to the first substrate until reaching an installation depth below the first substrate top surface,
the movement processor configured to control a locking member actuator to engage the locking mechanism to move the locking member from the locking member second position to the locking member first position after the first arm reaches the installation depth,
the movement processor configured to control a linear actuator associated with the positioning body to move the positioning body from the tool first position to the tool first position after the locking member moves from the locking member second position to the locking member first position,
the movement processor configured to control the linear positioning device to raise the first arm relative to the first substrate after moving the positioning body from the tool first position to the tool second position.

11. The positioning tool of claim 3, further comprising:
a spray outlet on one of the first arm downwardly-extending member internal face surface, the narrow vertically-oriented first arm downwardly extending external face, and a first arm first edge intermediate the narrow vertically-oriented first arm downwardly-extending member internal face and the narrow vertically-oriented first arm downwardly extending member external face,
the spray outlet in communication with a spray passage through the first arm,
the spray passage in communication with a spray reservoir,
the spray reservoir containing an application liquid selected from the group of adhesive, epoxy, solvent, and elastomer.

12. The positioning tool of claim 2, wherein
the narrow vertically-oriented first arm downwardly-extending member internal face is convex.

13. The positioning tool of claim 2, further comprising:
a removal body, the removal body configured to maintain position in contact with a top surface of the resiliently-compressible building component and to an adjacent first substrate when the first arm contacts the first substrate and the positioning body is in the tool second position.

14. The positioning tool of claim 1, further comprising:
a locking member,
the locking member rotationally attached at a locking member first end to the first arm at a first arm lower end,
the locking member having a locking member second end opposite the locking member first end,
the locking member having a locking member first position wherein the locking member downwardly descends from the first arm lower end and a locking member second position wherein the locking member second end is intermediate the first arm lower end and the second arm; and
a locking mechanism configured to move the locking member between the locking member first position and the locking member second position.

15. The positioning tool of claim 14, wherein
the locking member second end is perpendicular the first arm in the locking member second position.

16. The positioning tool of claim 1, further comprising:
a signal receiver configured to transmit a signal received from the resiliently-compressible building component to a status processor.

17. The positioning tool of claim 1, further comprising:
a position processor configured to record the quantity of changes from the tool first position to the tool second position.

18. The positioning tool of claim 1, wherein the second arm is parallel to the first arm.

19. The positioning tool of claim 1, further comprising a mechanical repositioning device configured to relocate the positioning body controlled by an operator.

20. The positioning tool of claim 1, wherein a lower end distance between a first arm lower end and a second arm lower end is less than the distance between a point of attachment of the first arm to the positioning body at the positioning body first connection end and a point of attachment of the second arm to the positioning body at a positioning body second connection end.

21. A positioning tool for use with a compressed expansion joint seal, comprising:
a plurality of adjustable adjacent spaced-apart armatures,
each armature having a first arm, a second arm, and a positioning body,
the first arm having a first arm downwardly-extending member,
the first arm downwardly-extending member having a narrow vertically-oriented first arm downwardly-extending member internal face and a narrow vertically-oriented first arm downwardly extending member external face,
the second arm having a second arm downwardly-extending member,
the second arm downwardly-extending member having a narrow vertically-oriented second arm downwardly-extending member internal face and a narrow vertically-oriented second arm downwardly extending member external face,
the positioning body attached to the first arm at a positioning body first connection end,
the positioning body attached to the second arm at a positioning body second connection end,
the positioning body positioned above the first arm downwardly-extending member and the second arm downwardly-extending member,
the positioning body configured to maintain the first arm relative to the second arm in tool first position,
wherein in the tool first position the narrow vertically-oriented first arm downwardly-extending member internal face contacts a resiliently-compressible building component, the resiliently-compressible building component in compression, and the narrow vertically-oriented second arm downwardly-extending member internal face oppositely contacts the resiliently-compressible building component, the narrow vertically-oriented first arm downwardly-extending member internal face distant the narrow vertically-oriented second arm downwardly-extending member internal face by a tool first position width,
the positioning body configured to permit the first arm and the second arm to move from the tool first position to a tool second position at a positioning body rate not greater than a rate of expansion of the resiliently-compressible building component while maintaining the narrow vertically-oriented first arm downwardly-extending member internal face in contact with the expansion joint seal and while maintaining the narrow vertically-oriented second arm downwardly-extending member internal face in opposing contact with the resiliently-compressible building component, and
the positioning body configured to maintain the first arm relative to the second arm in the tool second position,
wherein in the tool second position the narrow vertically-oriented first arm downwardly-extending member internal face contacts the resiliently-compressible building component and the narrow vertically-oriented second arm downwardly-extending member internal face oppositely contacts the resiliently-compressible building component, the narrow vertically-oriented first arm downwardly-extending member internal face distant the narrow vertically-oriented second arm downwardly-extending member internal face by a tool second position width, the second position width greater than the tool first position width, the tool second position width being at least 105% of the tool first position width and not more than 150% of the tool first position width.

22. A system for positioning an expansion joint seal adjacent a first side of a first substrate, comprising:
a positioning tool, the expansion joint seal, and the first substrate,
the positioning tool having a first arm, a second arm, and a positioning body,
the first arm having a first arm downwardly-extending member,
the first arm downwardly-extending member having a narrow vertically-oriented first arm downwardly-extending member internal face and a narrow vertically-oriented first arm downwardly extending member external face,
the second arm having a second arm downwardly-extending member,
the second arm downwardly-extending member having a narrow vertically-oriented second arm downwardly-extending member internal face and a narrow vertically-oriented second arm downwardly extending member external face,
the positioning body attached to the first arm at a positioning body first connection end,
the positioning body attached to the second arm at a positioning body second connection end,
the positioning body positioned above the first arm downwardly-extending member and the second arm downwardly-extending member,
the positioning body configured to maintain the first arm relative to the second arm in tool first position,
wherein in the tool first position the narrow vertically-oriented first arm downwardly-extending member internal face contacts a resiliently-compressible building component, the resiliently-compressible building component in compression, and the narrow vertically-oriented second arm downwardly-extending member internal face oppositely contacts the resiliently-compressible building component, the narrow vertically-oriented first arm downwardly-extending member internal face distant the narrow vertically-oriented second arm downwardly-extending member internal face by a tool first position width,
the positioning body configured to permit the first arm and the second arm to move from the tool first position to a tool second position at a positioning body rate not greater than a rate of expansion of the resiliently-compressible building component while maintaining the narrow vertically-oriented first arm downwardly-extending member internal face in contact with the expansion joint seal and while maintaining the narrow vertically-oriented second arm downwardly-extending member internal face in opposing contact with the resiliently-compressible building component, and
the positioning body configured to maintain the first arm relative to the second arm in the tool second position,
wherein in the tool second position the narrow vertically-oriented first arm downwardly-extending member internal face contacts the resiliently-compressible building component and the narrow vertically-oriented second arm downwardly-extending member internal face oppositely contacts the resiliently-compressible building component, the narrow vertically-oriented first arm downwardly-extending member internal face distant the narrow vertically-oriented second arm downwardly-extending member internal face by a tool second position width, the second position width greater than the tool first position width, the tool second position width being at least 105% of the tool first position width and not more than 150% of the tool first position width;
the positioning tool configured to maintain the expansion joint seal between the first arm downwardly-extending member and second arm downwardly-extending member in a lesser-compressed state in the tool second position, a density of the expansion joint seal being greater in the tool first position than in the tool second position, and
the first arm downwardly-extending member configured for positioning adjacent the first side of the first substrate.
